(19) United States
(12) Patent Application Publication
(10) Pub. No.: US 2005/0074030 A1
(43) Pub. Date: Apr. 7, 2005

(54) Method for increasing network throughput of cellular wireless packet network by loading control

(75) Inventors: Jae-Hee Cho, Seoul (KR); Soon-Young Yoon, Seongnam-si (KR); Sang-Hoon Sung, Suwon-si (KR); In-Seok Hwang, Seoul (KR); Hoon Huh, Seongnam-si (KR); Kwan-Hee Roh, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/957,778

(22) Filed: Oct. 4, 2004

(30) Foreign Application Priority Data
Oct. 2, 2003 (KR) 2003-68761

(51) Int. Cl. H04J 3/24

(52) U.S. Cl. 370/474

(57) ABSTRACT

A method for increasing a network throughput of a cellular wireless packet network by controlling loading on a transmission frame in a cellular wireless packet network. In the method, transmission data are mapped to a transmission frame to be transmitted in a cellular wireless packet network in which a plurality of base stations and a plurality of mobile stations transmit packet data to each other. The method includes the steps of: dividing the transmission frame into a plurality of transmission groups each of which includes at least one slot; and constructing the transmission frame by allocating data with different loadings to the divided transmission groups.

### PRIORITY

This application claims priority to an application entitled “Method For Increasing Network Throughput of Cellular Wireless Packet Network By Loading Control” filed in the Korean Industrial Property Office on Oct. 2, 2003 and assigned Serial No. 2003-68761, the contents of which are hereby incorporated by reference.

### BACKGROUND OF THE INVENTION

1. Field of the Invention

The present invention relates to a mobile communication system, and more particularly to a method for increasing a network throughput of a cellular wireless packet network.

2. Description of the Related Art

According to current developments in mobile communication technologies and users' increasing demands for a variety of services, requirements for high speed cellular wireless packet services are rapidly increasing. Therefore, research is being conducted on methods for increasing the quantity of data to be transmitted with the limited bandwidth resources of cellular wireless packet system.

Meanwhile, methods for increasing the number of channels per unit area in the cellular system include a method of reducing a range of each cell and a method of controlling a “frequency reuse index”. Here, the frequency reuse index (N) is a parameter indicating a frequency efficiency in a cellular system, specifically indicating the number of cells to which the entire frequency bands are distributed.

For example, when a given entire frequency range is divided into seven traffic channels and the seven traffic channels are distributed to seven cells, respectively, the frequency reuse index is seven. Here, the group of the seven cells assigned seven different frequencies are called a “cell cluster”. Therefore, it can be said that a frequency reuse index refers to the number of cells included in a cell cluster.

FIGS. 1A through 1F illustrate various shapes of cell clusters having various frequency reuse indices according to the prior art.

FIGS. 1A through 1F show cell arrangements of cell clusters including omni-directional cells and 3-sectored cells when each cell has a regular hexagonal shape and the cell clusters have frequency reuse indices of 3, 4 and 7, respectively, each corresponding to the number of the cells. FIGS. 1A, 1B and 1C illustrate cell arrangements of omni-directional cell clusters and FIGS. 1D, 1E and 1F illustrate cell arrangements of sectored cell clusters.

Here, the omni-directional cell refers to a cell in which a base station is located at the center of the cell and provides a service through an omni-directional antenna transmitting electromagnetic waves in all directions, and the sectored cell refers to a cell which is divided into multiple sectors and includes a specific antenna for transmitting electromagnetic waves in a specific direction and RF (Radio Frequency) equipment for each sector. It is easier to control interference in the sectored cell than in the omni-directional cell. Further, the sectored cell has a larger antenna gain than the omni-directional cell, so that the sectored cell has a larger area to which one base station can provide service than that of the omni-directional cell.

According to calculations of the number of traffic channels which can be allocated to each cell from 500 traffic channels in the cell clusters shown in FIGS. 1A through 1F in order to determine each frequency reuse index, the calculated number of traffic channels is 166 when the frequency reuse index N is 3 (500/3=166), 125 when the frequency reuse index N is 4 (500/4=125), 71 when the frequency reuse index N is 7 (500/7=71), and 42 when the frequency reuse index N is 12 (500/12=42). It is noted from the results of the calculation that the smaller the frequency reuse index is, the larger the number of the traffic channels allocatable to each cell is. In other words, the smaller the frequency reuse index is, the larger the number of the traffic channels allocatable to each cell is and the larger the number of channels per unit area is.

Hereinafter, a cell arrangement of a cell cluster having a frequency reuse index of 7 will be explained with reference to FIG. 2.

The cell cluster shown in FIG. 2 includes conventional cells reusing the same frequency channels. Each of the cells shown in FIG. 2 uses the same frequency for distant cells but not for adjacent cells. That is to say, FIG. 2 illustrates a cell arrangement of cell clusters each of which uses seven frequencies, that is, has a frequency reuse index of 7.

Meanwhile, when the cell clusters have a frequency reuse index, which is too small the cells using the same frequency are located too close to each other as shown in FIGS. 1A through 2 and may interfere with each other. Therefore, it is not recommended to reduce the frequency reuse index without limit.

The frequency reuse index is influenced by electric wave environment and is dependent most on a least Carrier to Interference and Noise Ratio (CINR) required by a mobile communication system. As the least CINR required by a mobile communication system increases, the cells using the same frequency channel must be located more distant from each other, so that the interference between the cells are reduced. In contrast, when the least CINR required by a mobile communication system is small, increase of the interference is allowable to a certain degree. Therefore, a signal which contains interference from other cells can be restored even when the frequency reuse index is reduced and the cells using the same frequency are located close to each other.

For omni-directional cells each having a hexagonal shape, change in interference quantity according to the frequency reuse index can be calculated by the following Equation 1:

$$\frac{D}{R} = \sqrt{3 N} \qquad Equation 1$$

where D represents a distance between cells using the same frequency and R represents a cell radius. It is also noted from Equation 1 that, in the case of omni-directional cells each having a hexagonal shape, the cell radius and the distance between the cells using the same frequency are functions of the frequency reuse index. Therefore, from Equation 1, the distance between the cells using the same frequency is calculated as 9.2 km when each of the cells has a cell radius of 2 km and a frequency reuse index of 7.

Hereinafter, a distance between commonly-used 3-sectored cells according to frequency reuse indices will be described with reference to FIG. 3.

FIG. 3 illustrates a distance between conventional 3-sectored cells according to frequency reuse indices. It is preferred that the distance between the cells is expressed by a multiple of the cell radius, because the distance is the most important factor in reducing the magnitude of the electromagnetic wave. When 3-sectored cells are arranged as shown in FIG. 3, the distance between the cells using the same frequency can be expressed as the following Equation 2.

$$N = \frac{7}{21} , \frac{D}{R} = \sqrt{63} ≅ 7.9 \\ N = \frac{4}{12} , \frac{D}{R} = 6 \\ N = \frac{3}{9} , \frac{D}{R} = 3 \times \sqrt{3} ≅ 5.2 \qquad Equation 2$$

N represents a frequency reuse index, D represents a distance, and R represents a cell radius. From Equation 2, it is noted that the reduction of the frequency reuse index by designing a system (base station or mobile station) required for the restoration of signals to have a reduced CINR in a mobile communication system can make a large contribution to the increase of the channel throughput.

Usually, a digital cellular communication system has larger throughput than that of an analog cellular communication system. In considering the number of traffic channels which can be provided by a given frequency band in the above-mentioned cell clusters, an analog AMPS (Advanced Mobile Phone Service) system has 500 traffic channels and a digital GSM (Global System for Mobile Telecommunication) system has 600 traffic channels for a frequency band of 15 MHz. Thus, the digital system has a throughput 1.2 times larger than that of the analog system in simple comparison to the entire number of traffic channels.

However, the AMPS system has a CINR of 18 dB which allows the AMPS system to employ a frequency reuse index of 7 and the GSM system has a CINR of 6 dB which allows the GSM system to employ a frequency reuse index of 4. In conclusion, the GSM system has a throughput at least twice larger than that of the AMPS system.

Meanwhile, a system employing a Code Division Multiple Access (CDMA) scheme has a theoretical frequency reuse index of 1 and an actual frequency reuse index of 1/0.6. Therefore, the system employing the CDMA scheme has a channel throughput larger than the channel throughput of any other wireless access system scheme. (e.g., an analog scheme of Advanced Mobile Phone Service system (AMPS) and an analog scheme of Time Digital Multiple Access (TDMA) or a digital scheme of Global System for Mobile Communication (GSM)). That is to say, in consideration of only the frequency reuse index, the CDMA system has a throughput four times greater than that of the analog system and 2 to 2.4 times greater than that of the TDMA system. Therefore, it is noted that the frequency reuse index is the main reason why the CDMA system has a channel throughput which is greater than the channel throughput of any other wireless access system.

As described above, proper utilization of the a frequency reuse scheme will enhance system efficiency and enhance the use of frequency resources of a cellular system. Here, the frequency reuse scheme refers to a technique allowing a frequency already used in a specific cell/sector of a cellular system to be reused by another cell/sector in the same cellular system as described above, and the frequency reuse rate implies a gap between cells/sectors using the same frequency.

The frequency reuse rate may be determined by a reception quality (e.g., a CINR) necessary in order to enable a specific cellular system to operate under a specific transmission condition. In particular, a system having a frequency reuse rate of “1” in all cells/sectors using the same frequency is advantageous that it enhances in system throughput and easy installation of the system.

The conventional cellular systems usually employ various methods of dividing an available band/time into multiple bands/periods in order to increase the number of users. In order to provide a high speed packet service in such conventional cellular systems, it is necessary to simultaneously access the divided multiple resources. However, such methods as described above increase the overall of the system expense, Therefore, it is necessary to enable a user to access a wideband (resource) in order to provide a high speed wireless packet service.

Meanwhile, a CINR of a system having a frequency reuse rate of “1” depends on the location of the reception station. Therefore, a reception station located in a shadowing area or a boundary area between cells/sectors has a very low CINR, while a reception station located adjacent to a base station has a relatively high CINR.

However, it is inefficient for an entire system to apply the same frequency reuse rate to multiple mobile stations having different CINRs in the same cell despite the fact that the frequency reuse rate depends on the CINR.

### SUMMARY OF THE INVENTION

Accordingly, the present invention has been made to solve the above-mentioned problems occurring in the prior art, and an object of the present invention is to provide a method for increasing a network throughput of a cellular wireless packet network by controlling loading on a transmission frame in a cellular wireless packet network.

It is another object of the present invention to provide a method capable of improving a systems efficiency by applying different frequency reuse rates to multiple mobile stations having different CINRs in the same cell in a cellular wireless packet network.

It is another object of the present invention to provide a method capable of improving a systems performance by controlling the interference between cells/sectors through control of frequency reuse rates according to the location of individual users.

It is another object of the present invention to provide a method capable of controlling the amount of interference by controlling the quantity of resources allocated during a specific unit period in a wideband wireless packet network.

It is still another object of the present invention to provide a method capable of controlling interference between cells/sectors by controlling the quantity of resources allocated to the transmission side which interfere with each other during a specific unit period in a wideband wireless packet network.

In order to accomplish these and other objects, there is provided a method for mapping transmission data to a transmission frame and transmitting the transmission frame in a cellular wireless packet network in which a plurality of base stations and a plurality of mobile stations transmit packet data to each other. The method comprises the steps of dividing the transmission frame into a plurality of transmission groups each of which includes at least one slot; and constructing the transmission frame by allocating data with different loadings to the transmission groups.

In accordance with another aspect of the present invention, there is provided a method for mapping transmission data to a transmission frame in a cellular wireless packet network in which a plurality of base stations and a plurality of mobile stations transmit packet data to each other. The method comprises the steps of arranging packet data to be transmitted to the mobile stations according to transmission qualities of the mobile stations; and allocating the arranged packet data to predetermined time slots within the transmission frame in a sequence starting from packet data to be transmitted to a mobile station having a smallest transmission quality.

### BRIEF DESCRIPTION OF THE DRAWINGS

The above and other objects, features and advantages of the present invention will be more apparent from the following detailed description taken in conjunction with the accompanying drawings, in which:

FIGS. 1A through 1F illustrate various shapes of cell clusters having various frequency reuse indices according to the prior art;

FIG. 2 illustrates a cell arrangement of cell clusters using the same frequency channel according to the prior art;

FIG. 3 illustrates a distance between conventional 3-sectored cells according to frequency reuse indices;

FIG. 4 illustrates time-selective allocation of resources based on CINRs according to the present invention;

FIG. 5 illustrates a method of generating a frame in a MAC layer according to the present invention;

FIGS. 6A through 6C illustrate a cell configuration of a cellular wireless packet network according to an embodiment of the present invention;

FIG. 7 illustrates a logical structure of a transmission frame according to an embodiment of the present invention;

FIG. 8 is a graph illustrating the quantity of transmission traffic of individual users and frames according to an embodiment of the present invention;

FIG. 9 illustrates a logical structure of a transmission frame according to another embodiment of the present invention;

FIG. 10 illustrates frame structures of different base stations according to an embodiment of the present invention; and

FIG. 11 is a flowchart of a method for mapping user packets in a frame according to an embodiment of the present invention.

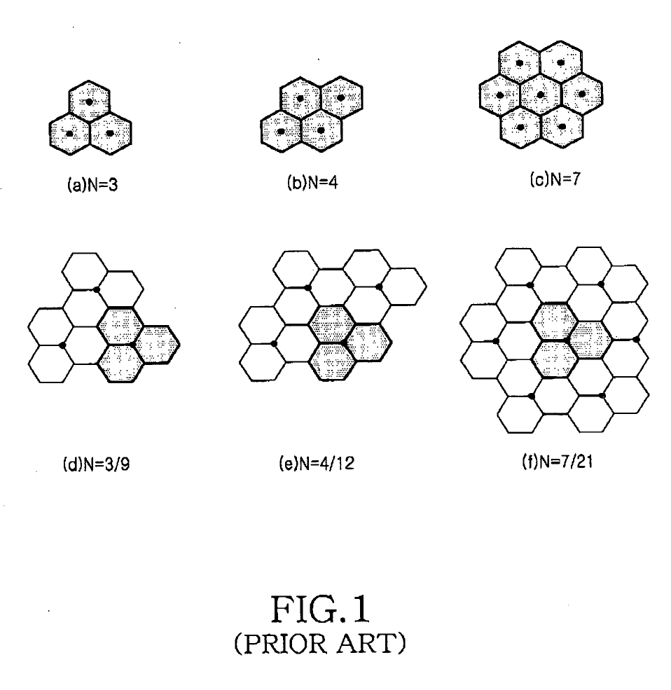

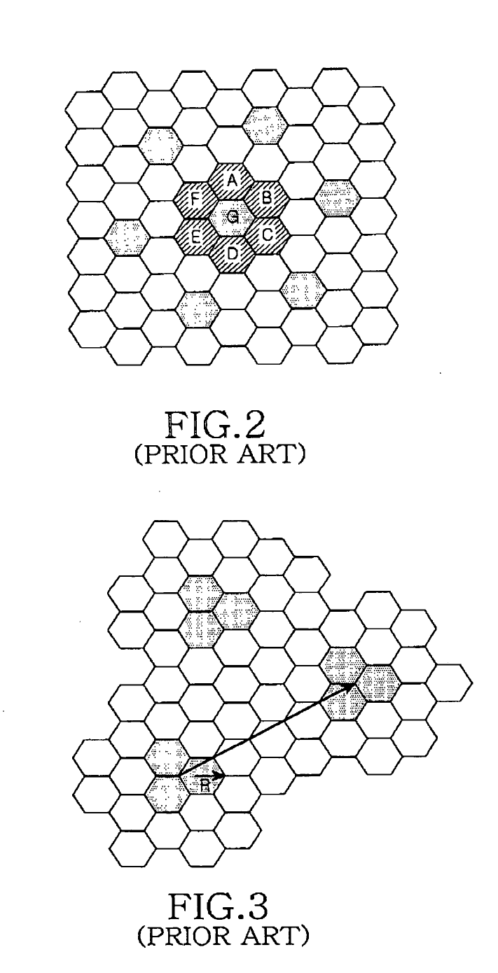

### DETAILED DESCRIPTION OF THE PREFERRED EMBODIMENT

Hereinafter, preferred embodiments of the present invention will be described in detail with reference to the accompanying drawings. In the following description, a detailed description of known functions and configurations incorporated herein will be omitted when it may make the subject matter of the present invention unclear.

As described below, the present invention proposes a method capable of improving a system efficiency by applying different frequency reuse rates to multiple mobile stations having different CINRs in the same cell in a cellular wireless packet network.

According to the present invention in order to improve the system efficiency, a method of controlling the frequency reuse rate according to the locations (or CINRs) of the users can be used. Especially, in the case of a wideband cellular wireless packet network, the quantity of interference can be controlled by controlling the quantity of resources allocated during a specific unit period in a wideband wireless packet network. That is, interference between cells/sectors can be controlled by controlling the quantity of resources allocated to the transmission side, which interfere with each other during a specific unit period.

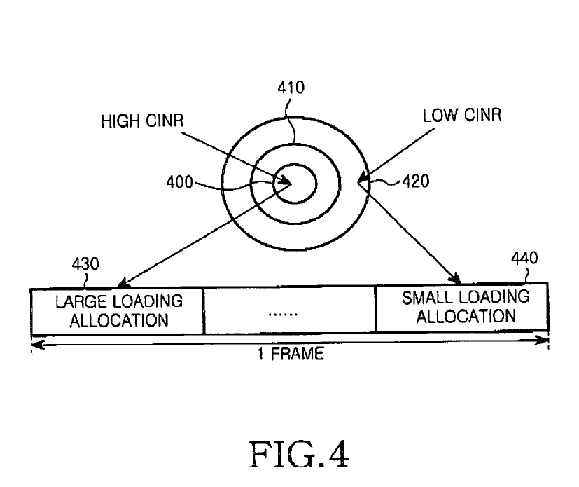

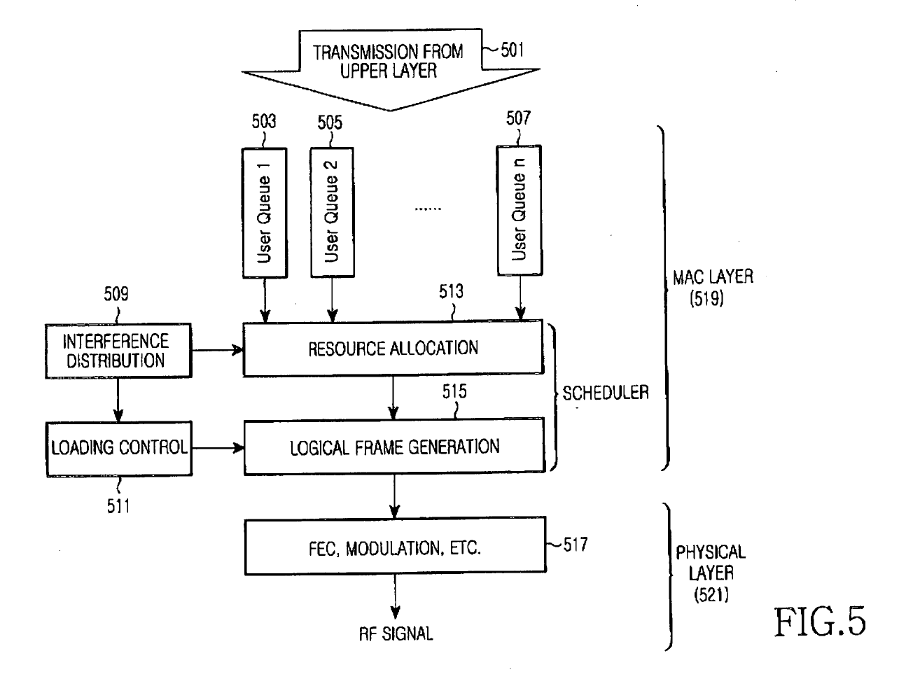

FIG. 4 illustrates a time-selective allocation of resources based on CINRs according to the present invention.

Referring to FIG. 4, a small loading (resource) is allocated (440) to reception stations 420 experiencing low CINRs during a specific unit time period (for example, a predetermined slot interval within one frame), while large loading (resource) is allocated (430) to reception stations 400 experiencing high CINRs during another specific unit time period different from the time period during which the small loading is allocated. Further, intermediate loading (resource) is allocated to reception stations 410 having intermediate CINRs during another specific unit time period which is different from the above-mentioned time periods.

Meanwhile, when the present invention is applied to the Time Division Multiple Access (TDMA) scheme, in the TDMA scheme, time frame may be divided into a dedicated interval and a shared interval and different loadings can be allocated to the two divided intervals. Specifically, in the dedicated interval, only one of transmitters interfering with each other is allowed to transmit a signal, thereby reducing the quantity of interference as much as possible. In contrast, in the shared interval, all of at least two transmitters interfering with each other are allowed to simultaneously use the same resource (time slot). This method allows mobile stations having good and bad CINRs to properly use the dedicated interval and the shared interval, thereby improving the transmission quality.

Also, the concept of the present invention can be applied to the above-mentioned method of controlling the quantity of interference (or loading) in a TDMA fixed wireless packet network in which both the base station and the mobile station use directional antennas.

More specifically, the shared interval is divided into an integer number of intervals having different loadings without the dedicated interval, and each base station transmits training signals to mobile stations which have newly entered the network or mobile stations which are already in the network according to sequences predetermined for each interval. Here, in consideration of the characteristic of only the sector type fixed network in which both the base station and the mobile station use directional antennas, only base stations of the sectors in the same cell participate in transmitting the training signals and the interference by other cells is not considered. Further, each mobile station measures transmission quality during each interval from the training signals and determines a range of the transmission-allowed interval.

When a packet to be transmitted has been generated, transmission of the packet to each mobile station is performed only range the transmission-allowed interval determined in advance as described above. Such division of intervals as described above enables more efficient transmission.

Further, the present invention provides a more improved method in which one transmission frame is divided into a plurality of time slots and different time slots are transmitted according to the location or the quantity of interference of the reception station. Especially, different quantities of resources may be allocated according to the quantity of interference so as to equalize the quantity of resources allocated by all base station transmitters as much as possible, thereby improving transmission efficiency in a multi-cell environment. Further, the resource allocation by each base station can be easily tuned.

Hereinafter, the above-mentioned method according to the present invention will be described in more detail with reference to drawings.

FIG. 5 illustrates a method of generating a frame in a Medium Access Control (MAC) layer according to the present invention.

Referring to FIG. 5, user data (or control information) transmitted 501 from an upper layer are transferred to a scheduler through an individual queues 503 through 507 in a MAC layer 519. A resource allocator in the scheduler plans a transmission sequence of the transferred data and plans and executes resource allocation (513) in consideration of the transmission sequence. Here, the resource allocation is carried out such that interference is distributed to the transmission data inputted through the individual queues in consideration of CINR between a base station and each mobile station.

The data allocated resources as described above are converted to a logical frame 515 which is then transferred to a physical layer 521. The physical layer 521 converts the logical frame into a transmission signal suitable for the cellular packet network and then transmits the signal. For example, the physical layer performs Forward Error Correction (FEC) or modulation for the received logical frame 517, RF processes the logical frame, and then transmits a converted signal.

Hereinafter, the logical frame generation block 515 according to the present invention will be described in more detail. The logical frame generation block 515 properly distributes resources according to the time slots in the frame by means of an interference signal distribution of reception stations or its corresponding distribution, thereby controlling the quantity of interference to other cells, that is, controlling the loading 511. In other words, the interference distribution block 509 shown in FIG. 5 confirms distribution of interference signals of the reception stations and controls the loading control block 511 based on the interference signal distribution information to allocated different loadings to mobile stations according to the quantities of interference of the mobile stations. For example, the control is made in such a manner that a small loading is allocated to a mobile station having a large quantity of interference from another cell. Therefore, the resource allocation block 513 allocates resources for data transmission to each mobile station according to interference distribution information, and the loading control block 511 maps the resource-allocated data to a predetermined frame such that loadings different according to frames are applied to the frames, thereby generating a logical frame. More specifically, a small loading (resource) is allocated to reception stations experiencing low CINRs during a specific unit time period, while large loading (resource) is allocated to reception stations experiencing high CINRs during another specific unit time period different from the time period during which the small loading is allocated. Further, intermediate loading (resource) is allocated to reception stations having intermediate CINRs during another specific unit time period which is different from the above-mentioned time periods.

When the control of the interference quantity as described above is simultaneously performed in all the base stations, the quantity of the interference by the other cells is also controlled. Although the above description is focused on the downlink to which the present invention is not limited, it is obvious that the same description can be given on the uplink.

Hereinafter, actual examples of allocation of resources to transmission frames according to the above-mentioned method will be described.

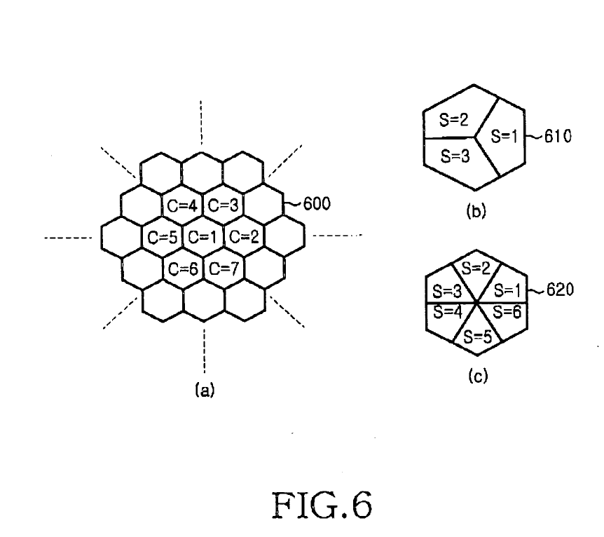

FIGS. 6A through 6C illustrate a cell configuration of a cellular wireless packet network according to an embodiment of the present invention.

A cellular wireless packet network according to an embodiment of the present invention can include base stations, sectors and cells, which are arranged as shown in FIGS. 6A through 6C. The base station is located at the center of each hexagonal cell and directionally transmits a signal for each sector. Here, FIG. 6A shows a plurality of hexagonal cells located in a group, in which a value of C written on each cell represents a number for identifying the cell. Further, FIGS. 6B and 6C show cells which include 3 divided sectors and 6 divided sectors, respectively. Of course, the present invention may be applied to a cell including any number of divided sectors as well as the 3 or 6 divided sectors.

Further, as shown in FIGS. 6A through 6C, the number of each cell can be represented by a variable C (C={1, 2, . . . , C}) and the number of each sector in each cell can be represented by a variable S (S={1, 2, . . . , S}). Here, S implies the total number of the sectors in one cell. In the following description, C and S are respectively used as variables for identifying each cell and each sector.

The present invention considers a system having a frequency reuse rate of “1”, that is, a system in which the same frequency is used in adjacent sectors and cells in a cellular wireless packet network such as the above-mentioned CDMA system. Here, the quantity of interference which one signal from a base station makes on an adjacent cell and sector is controlled with a quantity of resource allocated to the signal. This method will be described later in more detail. Meanwhile, it is obvious that the present invention can be applied to a system not having a frequency reuse rate of “1”, that is, a system in which the same frequency is used in only distant sectors and cells. For convenience's sake, the description is based on an assumption that the signal is transmitted through transmission of frames in the cellular wireless packet network. However, the assumption can be generalized by limitlessly increasing the length of each frame.

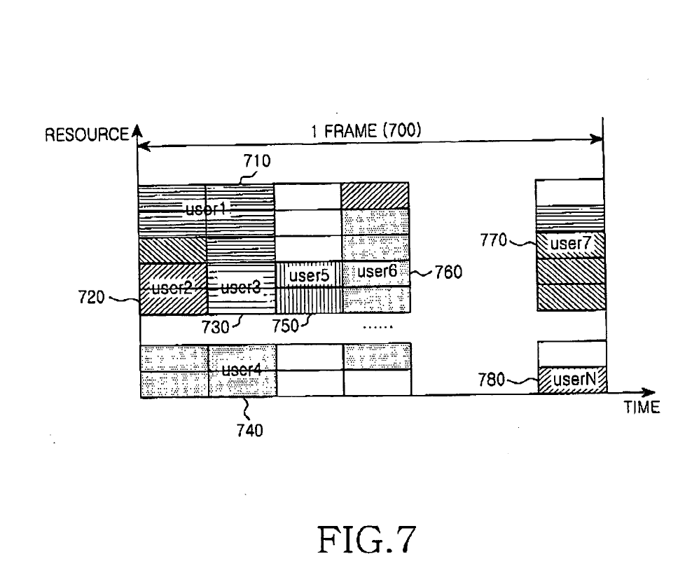

FIG. 7 illustrates a logical structure of a transmission frame according to an embodiment of the present invention.

In a cellular packet network according to the present invention as shown in FIG. 7, one transmission frame 700 may include a plurality of user packets (physical bursts) 710 through 780. The horizontal axis represents a time axis and the vertical axis represents an allocatable resource. For example, when the present invention is applied to a Frequency Division Multiple Access (FDMA) or an Orthogonal Frequency Division Multiple Access (OFDMA) system, the resource can be a frequency (or subcarrier). In contrast, when the present invention is applied to a CDMA system, the resource can be an orthogonal code.

In consideration of the characteristics of the data packet network, each packet for multiple users occupies only a part of the frame 700. The occupation of the packet in the above-mentioned frame has a direct influence on the magnitude of a physically generated signal and the physical signal functions as an interference to adjacent cells and sectors.

That is, in the time slots within the frame, which are occupied by user 1 710, user 2 720, user 3 730 and user 4 740, all available resources in the time-resource area are used in transmitting information. However, in the time slot within the frame occupied by user 5 750, only a part of the resources is allocated and the other part thereof is not allocated. In the two time areas, quantities of interference to the adjacent cells and sectors are different from each other. Further, in the time slots occupied by users 6 through N (i.e., 760 through 780 respectively) predetermined resources within the time-resource area are allocated according to quantities of data to be transmitted.

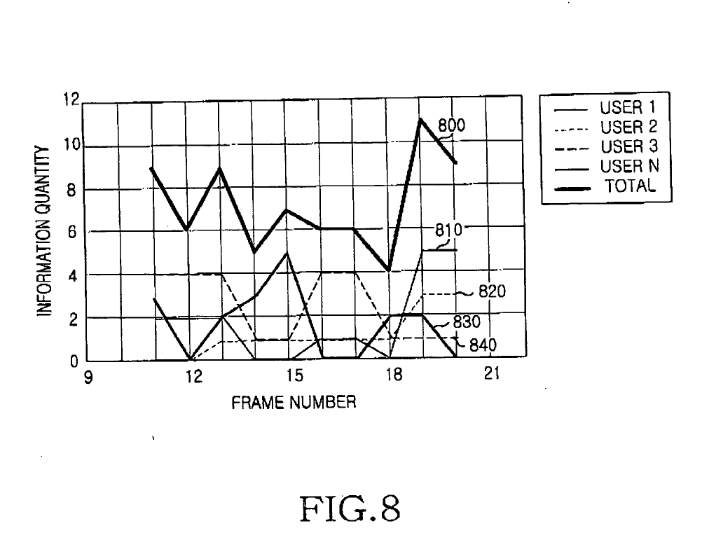

This is an example in which a plurality of user packets are multiplexed in one frame, so that different quantities of resources can be allocated according to time slots within the frame, can be often observed in a cellular wireless packet network. That is, in a wireless packet network using multiple user schemes such as TDMA, CDMA or OFDMA, the structure of the transmission frame as shown in FIG. 7 can be generated according to allocation of time, code, frequency (subcarrier) and power. FIG. 8 is a graph illustrating the quantity of transmission traffic of individual users and frames according to an embodiment of the present invention.

FIG. 8 schematically shows change of traffic to be transmitted by multiple users 810 through 840 for each frame and the quantity of entire traffic 800 to be transmitted in each frame in order to accept such change. The transmission traffic may change in each frame. Therefore, the quantity of the entire transmission traffic to be transmitted in each frame also changes according to time or according to individual sectors or cells. In a scheduling method according to the present invention, the quantity of transmission traffic is determined for each frame and resources are allocated to each frame in consideration of the quantity of the transmission traffic required by the individual users, the CINR of the reception station, etc.

The resources which can be allocated to the frame by the scheduler are differ according to the physical layer transmission schemes of the corresponding cellular wireless packet network. For example, time in a TDMA system, codes in a CDMA system, time and frequencies (sub-carriers) in an OFDMA system can be considered as allocatable resources. The present invention takes a general cellular wireless packet network into consideration and can be applied to the allocation of resources such as time, codes, frequencies and power, etc. which can be employed in the system regardless of the types of the resources.

The scheduler determines the quantity of traffic to be transmitted during one frame and allocates corresponding resources to the frame. In the following description, an average of resources allocated to said one frame within the frame is called L_{c,s} which is defined as a quantity of loading in the present invention. The quantity of loading is determined by the quantity of resources allocated to each frame as described above. Further, the quantity of loading functions as interference to other cells and sectors, which means that the quantity of allocated resources becomes the quantity of interference to other cells and sectors. Actually, L_{c,s} may change according to frames, and the change according to time can be disregarded by sufficiently extending the length of the frame as described above.

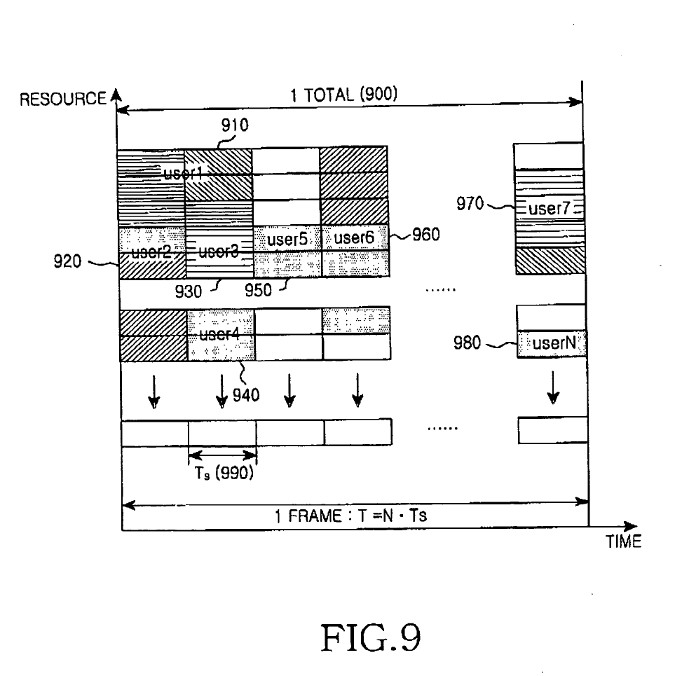

FIG. 9 illustrates a logical structure of a transmission frame according to another embodiment of the present invention.

Referring to FIG. 9, the logical transmission frame shown in FIG. 8 as described above is mapped to a physical frame according to a radio access standard of a corresponding cellular wireless packet network. The physical frame has a length of T and includes N physical time slots each having a length of Tₛ. Here, one physical time slot is a minimum unit during which the process by the physical layer is progressed. For example, a minimum unit in which channel coding is performed may be defined as the physical time slot. Here, a time slot occupied by a specific user packet within the logical frame may correspond to the physical time slot of the physical frame. That is, data to be transmitted to multiple users 910 through 980, may be mapped to the physical time slot 990 within the frame according to the frame.

Hereinafter, steps of a method of allocating resources in a cellular wireless packet network according to the present invention will be described in detail.

Loading Quantity Control Step

An object of the present invention is to control distribution of the quantity L_{c,s} of the loading allocated by the scheduler within the frame, thereby increasing system processing capacity and obtaining gain in the side of the system processing capacity (i.g. transmission channel capacity). Therefore, different quantities of loadings are allocated to different time slots within one frame while the quantity of the entire loading allocated to the entire frame is maintained the same. Moreover, it is preferred that loadings allocated to the time slots at the same positions within frames of all cells and sectors are arranged in the same sequence based on the quantities of loadings within each frame. This can be expressed as follows.

Let us assume that loading allocated to N physical time slots is l_{c,s,n}. Herein, subscripts c and s represent individual cells and sectors and subscript n represents the ordinal number of each of the physical time slots from 1 to N. Further, the n^{th} physical time slot is transmitted after passage of Tₛ·(n−1) from the start point of the frame. Then, the resource (loading) allocated to the frame can be expressed by the following Equation 3.

$${\sum }_{n = 1}^{N} {l}_{c , s , n} = {L}_{c , s} \cdot N \qquad Equation 3$$

Here, the l_{c,s,n} satisfies the following Equation 4 for all cells c and sectors s.
MAG_{—}ORD(l_{c,s,n}:n=1˜N)=MAG_{—}ORD(l_{c′,s′,n}:n=1˜N) Equation 4

The MAG_ORD function employed in Equation 4 is a function for arranging its parameters according to the sequence (seqn) of their magnitudes. For example, MAG_ORD(seq₁, seq₂, L, seqₙ) is a function for arranging seqₙ according to the sequence of magnitudes of its subscripts (from the smallest value to the largest value). When two parameters have the same magnitude, one parameter having the smaller subscript is placed before the other parameter having the larger subscript. For example, MAG_ORD(a₁=3, a₂=2, a₃=2,) is equal to {2, 3, 1 }. Further, in the function expressed as MAG_ORD(seq₁, seq₂, L, seqₙ)(m), m represents the m^{th} element of the function. Therefore, MAG_ORD(a₁=3, a₂=2, a₃=2,)(3) is equal to 1. This means that the element having the third magnitude is the first element a₁. Meanwhile, it is within the scope of the present invention to employ a function for arranging its parameters according to a sequence from the largest value to the smallest value in applying the present invention.

Considering that the transmission of time slots within the frame depends on the sequence of the subscripts as described above, the above-mentioned allocation of resources must meet the following conditions in all base stations. That is, time slots having small loadings interfere with time slots of other cells and sectors which also have small loadings, and time slots having large loadings interfere with time slots of other cells and sectors which also have large loadings. Here, more precise resource allocation may be possible through information exchange between base stations.

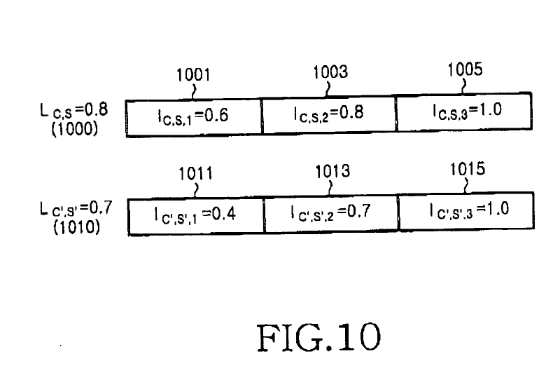

FIG. 10 illustrates frames to which the above-mentioned loading quantity control method according to an embodiment of the present invention is applied.

Referring to FIG. 10, two frames 1000 and 1010 are frames generated in different base stations during the same frame interval, to which the present invention is applied. For convenience, the description about FIG. 10 is based on an assumption that N is equal to 3. That is, allocation of resources according to difference between loadings is performed for three time slots. Of course, the present invention can be applied to frames having more divided time slots allocated different loadings.

The two frames shown in FIG. 10 have different average loadings of 0.7 and 0.8 for base stations and different loadings for individual time slots. However, it is noted that the sequence of magnitudes of loadings for the individual time slots is the same in the two frames. That is, in the base station having an average loading L_{c,s} of 0.8, a loading of 0.6 may be allocated to the first slot 1001 (that is, l_{c,s,1}=0.6), a loading of 0.8 may be allocated to the second slot 1003 (that is, l_{c,s,2}=0.8), and a loading of 1.0 may be allocated to the third slot 1005 (that is, l_{c,s,3}=1.0). Also, in the base station having an average loading L_{c,s} of 0.7, a loading of 0.4 may be allocated to the first slot 1011 (that is, l_{c′,s′,1}=0.4), a loading of 0.7 may be allocated to the second slot 1013 (that is, l_{c′,s′,2}=0.7), and a loading of 1.0 may be allocated to the third slot 1015 (that is, l_{c,′,s′,3}=1.0). In this way, the present invention employs allocation of loadings which are different according to the time slots and are determined for the same time slot in consideration of interference between the base stations, thereby enabling a system influenced which minimizes interference between the base stations as possible to be efficiently designed.

Meanwhile, in a cellular wireless packet system based on an OFDMA scheme, the quantity of loading can be controlled by allocating different numbers of sub-carriers to time slots. Further, in another method according to the present invention, from among the entire sub-carriers, a predetermined number of sub-carriers are grouped and defined as a sub-channel, and the quantity of loadings may be controlled by allocating different numbers of sub-channels to the time slots. In the same manner, in the CDMA or TDMA system also, the quantity of loadings can be controlled through the allocation of codes and time slots.

Step of Mapping between User Packets and Time Intervals within a Frame

Mapping of user packets is carried out for the time slots of the frame allocated loadings as described above. That is, the user packets are mapped to the time slots having different loadings according to reception states of a receiver. Here, reception state refers to the interference quantity (that is, a CINR) in the receiver or a measured value corresponding to the CINR. In the following description, the CINR is employed as an example.

In mapping the user packets to the time slots having different loadings according to the reception states of the receiver, a packet to be received by a receiver having a higher CINR is mapped to a time slot allocated a larger loading before a packet to be received by a receiver having a lower CINR is mapped to a time slot allocated a lower loading, and a packet to be received by a receiver having the lowest CINR is finally mapped to a time slot allocated a smallest loading.

Meanwhile, in contrast to the above-mentioned method, the mapping may be carried out in a sequence from a packet to be received by the receiver having the lowest CINR to a packet to be received by the receiver having the highest CINR. That is, since the entire loading is equal to a sum of loadings allocated to the packets to be transmitted, both of the above-mentioned methods can satisfy the transmission requirement by the scheduler. Here, in order ensure flexibility for the allocation, several successive time slots in MAG_ORD(l_{c,s,n}: n=1˜N) may be grouped and be subjected to the same processing as described above.

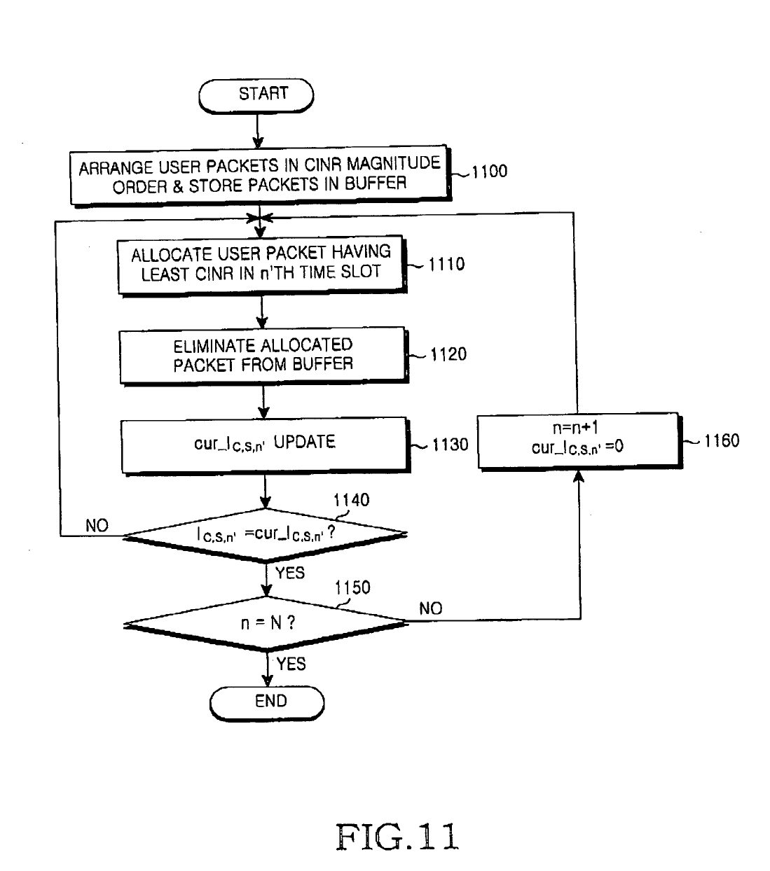

FIG. 11 is a flowchart of a method for mapping user packets in a frame according to an embodiment of the present invention.

In the following description with reference to FIG. 11, n′ refers to MAG_ORD(l_{c,s,n}: n=1˜N)(n) and cur_l_{c,s,n′} refers to a quantity of loading or resources allocated from n′^{th} time slot to the present.

Referring to FIG. 11, user packets to be transmitted in a corresponding frame are arranged in a sequence from the largest CINR to a receiver having the lowest CINR of receivers for receiving the user packets and are then stored in a buffer (step 1100). The arranged packets are mapped to time slots in a sequence from a time slot having the smallest loading to a time slot having the largest loading and the mapped packet is eliminated from the arranged packet. That is, the user packet having the smallest CINR is allocated to the n′^{th} time slot (step 1110) and the allocated packet is eliminated from the buffer (step 1120).

Then, loading cur_l_{c,s,n′} due to the packet allocated to the current time slot is updated (step 1130) and it is compared whether the loading cur_l_{c,s,n′} due to the packet allocated to the current time slot is equal to a predetermined loading as described above (step 1140). When the loading cur_l_{c,s,n′} due to the packet allocated to the current time slot is equal to a predetermined loading (l_{c,s,n}=cur_l_{c,s,n′}) (step 1140), a packet allocated to the next time slot is mapped. The time slot having a next largest loading. In contrast, when the loading cur_l_{c,s,n′} due to the packet allocated to the current time slot is not equal to the predetermined loading (l_{c,s,n}=cur_l_{c,s,n′}) (step 1140), allocation of the current packet is repeated from step 1110.

Meanwhile, the above-mentioned packet allocation process is repeated until all the user packets are mapped to the frame (steps 1150 and 1160).

In a cellular wireless packet network employing the control of loading and the mapping of user packets as described above according to the present invention, mobile stations located at positions having less interference are operated with larger loadings and mobile stations located at positions having more interference are operated with smaller loadings. Especially, such a characteristic as described above is continuously maintained even when the CINR largely changes due to movement of a mobile station or change of loading of an adjacent cell/sector.

Feedback of Interference Quantity Information

In order to implement the present invention, each base station must know CINRs of mobile stations. Therefore, it is necessary to feedback the Channel Quality Information (CQI) of receivers of mobile stations. In order to efficiently implement the present invention, it is possible to feedback only a CINR of a time slot having a largest loading instead of feedbacking CINRs of all time slots. This is possible because the quantity of loading is relatively controlled according to CINR of each mobile station in the method according to the present invention. Therefore, the above property is very important characteristic of the present invention which enables the reception quality to be repeatedly measured and fedback in a mobile environment.

Sometimes, it is necessary to feedback all of CINRs or corresponding measured values of time slots having different loadings. Then, it is possible to feedback all of the CINRs in the form of Pulse Code Modulation (PCM) value. As another method for reducing the size of the feedback information, it is possible to feedback only one CINR in the form of PCM value together with differences between the other CINRs and the fedback PCM value. As still another method, it is possible to feedback only one CINR (largest or smallest) in the form of PCM value together with differences between the other CINRs and the fedback PCM value arranged in ascending powers or descending powers.

Arrangement of Time Slots having a Specific Loading in Downlink

In the present invention as described above, although the sequence of time slots within the frame is not predetermined, it may be advantageous to map a time slot having a specific loading to a specific location within the frame when necessary. Especially, control information of a current frame in a Time Division Duplex (TDD) downlink must be received before anything else by all receivers in a service area and is thus preferred to be located at the foremost position of a frame. Therefore, the object of the present invention can be more efficiently achieved by locating a time slot having a smaller loading at a more fore part of a TDD downlink frame.

Test Results

Hereinafter, the performance of the present invention will be verified by means of results of computer simulation tests with respect to the average unit transmission rate for each sector (bits/Hz/Sec). In the simulations, average unit transmission rates for sectors of a central cell were examined for a model including 19 cells each having 3-sectors. Further, 3.8 was employed as an index for path attenuation, a single-path model was employed in tests including fading, and 8 dB was employed as a standard deviation for shadowing in tests including shadowing.

Further, in the tests according to the present invention, ideal antenna patterns and actual antenna patterns are compared with each other. For such comparison, the case where the same loading is uniformly allocated to an entire frame and the case where different loadings are allocated to time slots according to the present invention were compared with each other. Table 1 shows results of the tests.

TABLE 1

| | Ideal antenna pattern | | | Actual antenna pattern | | | Actual antenna pattern | | |
|---|---|---|---|---|---|---|---|---|---|
| | (No fading, no shadowing) | | | (No fading, no shadowing) | | | (fading, shadowing) | | |
| L_{c,s}(%) | 60 | 80 | 99.9 | 60 | 80 | 99.9 | 60 | 80 | 99.9 |
| Uniform allocation | 1.2290 | 1.4784 | 1.6940 | 0.8530 | 0.9715 | 1.0651 | 0.7548 | 0.8730 | 0.9645 |
| (bps/Hz) | | | | | | | | | |
| Method of Invention | 1.6663 | 1.6711 | 1.6950 | 1.0588 | 1.0665 | 1.0658 | 0.9719 | 0.9646 | 0.9652 |
| (bps/Hz) | | | | | | | | | |
| Transmission rate | 35.5 | 13.0 | 0 | 24.1 | 9.8 | 0 | 28.8 | 10.5 | 0 |
| gain (%) | | | | | | | | | |

Referring to Table 1, the method according to the present invention shows a higher transmission rate than the uniform allocation method regardless of antenna pattern, fading and shadowing. Especially, it is noted that the method according to the present invention has a larger effect as lower total loadings.

As described above, the present invention enables even mobile stations having a bad reception quality to stably receive signals and mobile stations having a good reception quality to be allocated large loadings (resources), thereby improving the efficiency of communication systems. Further, the present invention enables the cellular wireless packet network to be less sensitive. Moreover, the present invention can reduce the quantity of feedback information and thus achieves improvement in periodic measurement of reception quality and feedback of measured information for compensating for differences in reception quality in a typical cellular wireless packet network.

While the present invention has been shown and described with reference to certain preferred embodiments thereof, it will be understood by those skilled in the art that various changes in form and details may be made therein without departing from the spirit and scope of the present invention as defined by the appended claims.

1. A method for mapping transmission data to a transmission frame and transmitting the transmission frame in a cellular wireless packet network in which a plurality of base stations and a plurality of mobile stations transmit packet data to each other, the method comprising the steps of:
dividing the transmission frame into a plurality of transmission groups each of which includes at least one slot; and
constructing the transmission frame by allocating data with different loadings to the transmission groups.

2. The method as claimed in claim 1, wherein the transmission groups are arranged in descending orders of loadings allocated to the transmission groups so as to be transmitted according to a sequence in which slots are transmitted.

3. The method as claimed in claim 1, wherein the transmission groups are arranged in ascending orders of loadings allocated to the transmission groups so as to be transmitted according to a sequence in which slots are transmitted.

4. The method as claimed in claim 1, wherein one of the transmission groups, which has a smallest loading, is mapped to a foremost transmission slot.

5. The method as claimed in claim 1, wherein one of the transmission groups, which includes a control signal, is mapped to a foremost transmission slot.

6. The method as claimed in claim 1, wherein the transmission frame is constructed in such a manner that an arrangement order of the transmission groups between the base station and adjacent base stations applies equally.

7. The method as claimed in claim 1, wherein user packet data to be transmitted are allocated to the transmission groups with different quantities according to reception qualities of corresponding mobile stations.

8. The method as claimed in claim 7, wherein the reception qualities of the mobile stations are Carrier to Interference and Noise Ratios (CINRs) measured in receivers.

9. The method as claimed in claim 7, wherein information on a reception quality of a receiver is transmitted to a corresponding base station at a predetermined interval.

10. The method as claimed in claim 7, wherein, when each of the receivers for receiving the transmission data has a low reception quality, the transmission data are mapped to a transmission group having a small loading.

11. The method as claimed in claim 1, wherein the constructed transmission frame is transmitted using a scheme selected from the group consisting of a TDMA scheme, a CDMA scheme, an OFDM scheme and an OFDMA scheme.

12. The method as claimed in claim 1, wherein a sum of loadings allocated to the transmission groups is equal to entire loadings allocated to the entire transmission frame.

13. A method for mapping transmission data to a transmission frame in a cellular wireless packet network in which a plurality of base stations and a plurality of mobile stations transmit packet data to each other, the method comprising the steps of:
arranging packet data to be transmitted to the mobile stations according to transmission qualities of the mobile stations; and
allocating the arranged packet data to predetermined time slots within the transmission frame in a sequence starting from packet data to be transmitted to a mobile station having a smallest transmission quality.

14. The method as claimed in claim 13, wherein the arranged packet data are temporarily stored in a buffer.

15. The method as claimed in claim 13, further comprising the steps of:
dividing the transmission frame into a plurality of transmission groups each of which includes at least one slot; and
constructing the transmission frame by allocating data with different loadings to the transmission groups.

16. The method as claimed in claim 15, wherein the transmission groups are arranged in descending powers of loadings allocated to the transmission groups so as to be transmitted according to a sequence in which slots are transmitted.

17. The method as claimed in claim 15, wherein the transmission groups are arranged in ascending orders of loadings allocated to the transmission groups so as to be transmitted according to a sequence in which slots are transmitted.

18. The method as claimed in claim 15, wherein one of the transmission groups, which has a smallest loading, is mapped to a foremost transmission slot.

19. The method as claimed in claim 15, wherein one of the transmission groups, which includes a control signal, is mapped to a foremost transmission slot.

20. The method as claimed in claim 15, wherein the transmission frame is constructed in such a manner that the transmission groups are arranged in an equal sequence in both one of the base stations and another base station adjacent to said one of the base stations from which the transmission frame is transmitted.

21. The method as claimed in claim 15, wherein user packet data to be transmitted are allocated to the transmission groups with different quantities according to reception qualities of corresponding mobile stations.

22. The method as claimed in claim 21, wherein the reception qualities of the mobile stations are Carrier to Interference and Noise Ratios (CINRs) measured in receivers.

23. The method as claimed in claim 21, wherein information on a reception quality of a receiver is transmitted to a corresponding base station at a predetermined interval.

24. The method as claimed in claim 21, wherein, when the receivers for receiving the data have low reception qualities, the user packet data are mapped to transmission groups having small loadings from among the transmission groups.

25. The method as claimed in claim 15, wherein the constructed transmission frame is transmitted using scheme selected from the group consisting of a TDMA scheme, a CDMA scheme, an OFDM scheme and an OFDMA scheme.

26. The method as claimed in claim 15, wherein a sum of loadings allocated to the transmission groups is equal to entire loadings allocated to the entire transmission frame.
